(19) United States
(12) Patent Application Publication
(10) Pub. No.: US 2005/0060894 A1
(43) Pub. Date: Mar. 24, 2005

(54) Twine cutter

(76) Inventor: Altony Armstrong, Kaycee, WY (US)

Correspondence Address: JOHN O.MINGLE, P. O. Box 1311, Laramie, WY, 82073-1311, US

(21) Appl. No.: 10/664,652

(22) Filed: Sep. 19, 2003

(51) Int. Cl. B26B 3/00

(52) U.S. Cl. 30/294

(57) ABSTRACT

A twine cutter that is simple, flexible, inexpensive, and easy to carry is composed of injection molded plastic designed in such a manner as to be convenient for one hand cutting of twine, particularly as utilized with hay bales.

### BACKGROUND OF INVENTION

1. Field of Invention

The present invention relates to a device used as an easily employed hand operated twine cutter especially designed for hay bales.

2. Background

The subject invention is commonly referred to as a twine cutter and is primarily designed for use with hay bales. Hay bales come in several shapes and the most traditional is rectangular; however, in modern times “round bales” have become more utilized since they are more efficient. All such hay bales are commonly held together with several twine pieces wrapped around each bale and these must be cut and removed before feeding the hay to livestock. This use of hay is often more prevalent in winter months where the weather often complicates the process including such twine removal. The subject invention is particularly convenient to use with one hand and store in a pocket, and further it is not expensive to manufacture.

In regards the subject invention the use of “twine” is employed as a generic term referring to not only the common aspect of a rope-like material used for baling hay, but also others made from nylon, plastic, sisal, cotton, hemp, or similar materials. Thus the subject invention could be employed for cutting string, strap or tape from packages or other held-together items.

Related United States patents include:

| No. | Inventor | Year |
|---|---|---|
| 5,878,498 | Mundt | 1999 |
| 5,709,143 | Bentley | 1998 |
| 5,815,930 | Kojima | 1998 |
| 5,485,641 | Machmeier et al. | 1996 |
| 3,856,341 | Florek | 1974 |

Referring to the above list, Mundt discloses a tool and method for manually cutting twine wrapped around a bale in the design of a modified hook with a sharpened edge for cutting. Such a hook type of tool is difficult to use and inconvenient to store in the pockets of pants, shorts, or coats, and further is essentially restricted to only hay bale usage.

Bentley discloses a round baler twine cutter designed to be placed on a hay baler machine to wind twine on new-formed round bales. Conversely the subject invention works manually cutting twine from bales.

Kojima discloses a non-metallic strap cutter designed primarily for two-handed use, and further designed for use with loose straps, not ones tightly engaged around an object.

Machmeier et al. disclose a cutter tool designed as a form of pliers and utilized primarily with insulation for electrical products. Such pliers design is inconvenient, inefficient, and expensive to try to utilize with twine cutting.

Florek discloses a hay hook and twine cutter as a large two-bladed hook with one blade for cutting and the other blade for hooking and is difficult to use and carry.

### SUMMARY OF INVENTION

The objectives of the present invention include overcoming the above-mentioned deficiencies in the prior art by designing a one hand operated twine cutter that is simple, flexible, inexpensive, and easy to carry.

### BRIEF DESCRIPTION OF DRAWINGS

FIG. 1 shows a perspective view of the twine cutter.

FIG. 2 shows a view of the twine cutter when lying flat.

FIG. 3 shows a hand holder side view of the twine cutter.

FIG. 4 shows a blade holder side view of the twine cutter.

### DETAILED DESCRIPTION OF INVENTION

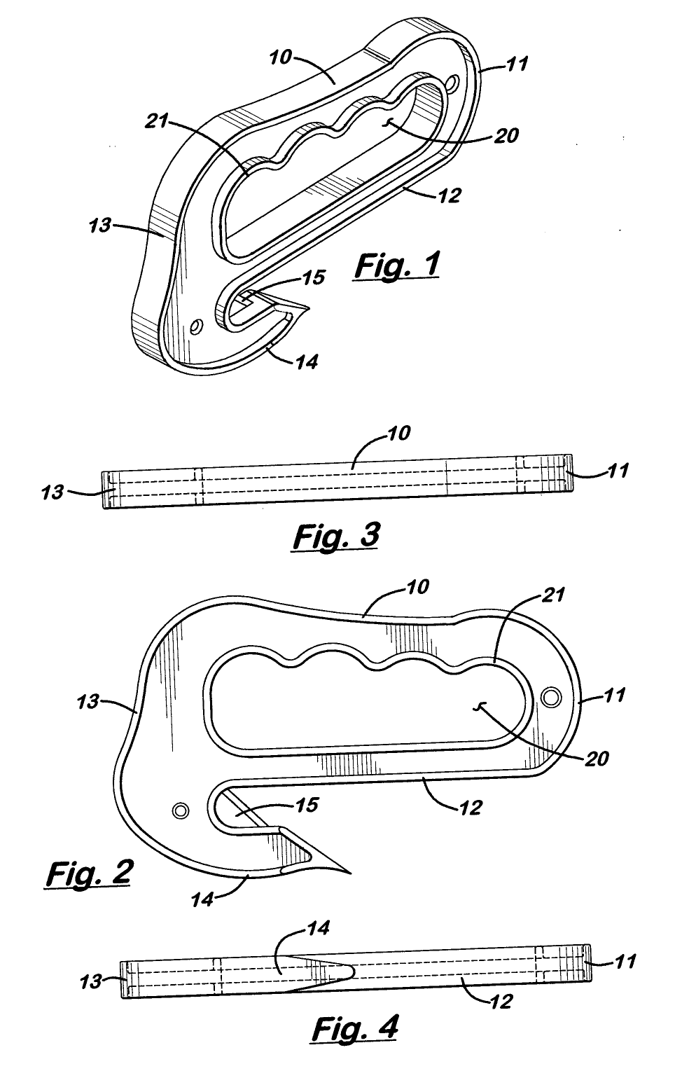

FIG. 1 identifies the main attributes of the subject invention with a perspective view that emphases the injection molding of the plastic frame so as to have wider plastic ridges for strength on the sides while leaving a strong inner support for the total frame. Referring to FIG. 2 the twine cutter is positioned lying flat. The top 13 represents holding the cutter up with the right hand so that the right side 10 is the hand holding strut connected between the top 13 and the bottom 11, which connects to the left side 12, which then connects to the top strut 13. These represent the main parts of the largely rectangular frame enclosing the opening 20. Such connections are potentially made from a wide variety of bolts, clamps, keys, nails, pins, rivets, screws, and similar items; however, the preferred method is to injection mold the frame as a single plastic piece. The blade holder strut 14 is added on to the top strut 13 at the intersection with the left side strut 12, and curves around to be substantially parallel with the left side 12 narrowing 10 down to a pinch for better hooking of wrapped twine, which pinch is shown more clearly in FIG. 4. The blade 15 is mounted permanently in the holder 14 at an approximately 45-degree angle so that it is secure for cutting of hard twine. Further the blade holder strut 14 is mounted in such a position to shelter the blade 15 in a safe manner. The inner right side 21 is designed to fit the fingers of the holding hand for better control of the cutter. FIG. 3 emphases the ridge nature of the plastic injection molding.

A twine cutter comprising a plane frame, composed of four struts making an approximate rectangular shape, enclosing a substantially rectangular opening, wherein said frame is composed of strong material to handle rough cutting, and wherein said opening serves as a hand holder for said cutter The blade holder strut composed of strong material, complete with connected high quality cutting blade, attaches to one end of said frame and is opposite the hand holder side, wherein said blade is imbedded at a diagonal angle in a recessed notch for safety.

There are multiple ways to attach such a blade to the frame, such as bolting, riveting, screwing, gluing, and many more. However, the preferred method is to employ plastic, such as polystyrene, to injection mold the cutting blade and blade holder strut along with the total frame in one operation. The blade holder strut is rounded to a pinch ending and aligned nearly parallel to the one side of the frame and serves as a device for hooking under a piece of tied twine. This allows potential movement of the hay bale for better alignment for the eventual cutting of the twine by the blade. The high quality blade represents a long lasting aspect of the twine cutter and is a commercial Stanley blade or equivalent.

The cutter's hand holder is designed with a wavy finger-fitting design in the inside of the frame opening opposite the blade holder for improved hand contact, and this further allows spacing of the hand holding design for small, medium and large hand sizes. Additionally the hand holder is designed with sufficient space that a large hand wearing a glove is easily accommodated. The twine cutter is conveniently six inches in height and four inches in width; however, other sizes are possible particularly when the cutter is designed for a given hand size.

A twine cutter comprising a plane substantially rounded rectangular frame composed of strong injection molded rounded plastic enclosing an elongated opening, wherein said opening serves as a hand holder for the cutter. The blade holder strut, complete with connected blade, composed of injection molded rounded plastic firmly attaches to said frame on the opposite side from the hand holder, wherein the blade is imbedded in a recessed notch for safety.

Preferably the frame and blade holder are injection molded as a single piece. Since the blade is made of high quality steel, it not replaceable in the injection molded configuration; however, it can be sharpened with a small file. The cutter being relatively inexpensive is then discarded and replaced with a new one once sufficient time has elapsed that the blade has worn out.

The foregoing description of the specific embodiments will so fully reveal the general nature of the invention that others can, by applying current knowledge, readily modify and/or adapt for various applications such specific embodiments without departing from generic concept, and therefore such adaptations or modifications are intended to be comprehended within the meaning and range of equivalents of the disclosed embodiments. It is to be understood that the phraseology or terminology herein is for the purpose of description and not of limitation.

1. A twine cutter comprising:
a plane frame, composed of four struts making an approximate rectangular shape, enclosing a substantially rectangular opening, wherein said frame is composed of strong material to handle rough cutting, and wherein said opening serves as a hand holder for said cutter; and
a blade holder strut composed of strong material, complete with connected blade, firmly attached to one end of said frame, wherein said blade is imbedded at a diagonal angle in a recessed notch for safety.

2. The cutter according to claim 1 wherein said frame including said blade holder strut further comprise one continuous injection molded piece of plastic.

3. The cutter according to claim 1 wherein said blade holder further comprises a rounded pinch ending aligned nearly parallel to one long side of said frame to serve as a device for hooking under a piece of twine to be then cut by said blade.

4. The cutter according to claim 1 wherein said hand holder further comprises a wavy finger-fitting design in the inside opening of the long side of said frame opposite said blade holder for improved hand contact.

5. The cutter according to claim 4 wherein said wavy finger-fitting design further comprises spacing of said design for small, medium and large hand sizes.

6. The cutter according to claim 1 wherein said hand holder further comprises sufficient space that a large gloved hand is easily accommodated.

7. The cutter according to claim 1 further comprising an overall dimension that fits into a coat pocket while still possessing sufficient size for easy hand operation.

8. The cutter according to claim 1 wherein said blade further comprises a high quality steel material.

9. A twine cutter comprising:
a plane substantially rounded rectangular frame composed of strong injection molded plastic enclosing an elongated opening, wherein said opening serves as a hand holder for said cutter;
a blade holder strut composed of strong injection molded plastic complete with connected blade imbedded in a recessed notch for safety; and
means for firmly attaching said blade holder to said frame on the opposite side from said hand holder.

10. The cutter according to claim 9 where said means for firmly attaching said blade hold to said frame further comprising said frame and said blade holder being injected molded in a single operation.

11. The cutter according to claim 9 further comprising an overall size allowing easy storage in a coat pocket.
